(19) United States
(12) Patent Application Publication
(10) Pub. No.: US 2015/0381734 A1
(43) Pub. Date: Dec. 31, 2015

(54) STORAGE SYSTEM AND STORAGE SYSTEM CONTROL METHOD

(71) Applicant: HITACHI, LTD., Chiyoda-ku, Tokyo (JP)

(72) Inventors: Tomoya EBIHARA, Tokyo (JP); Toshimichi KISHIMOTO, Tokyo (JP); Atsushi MIYAGAKI, Tokyo (JP); Shinichirou KANNO, Tokyo (JP)

(73) Assignee: Hitachi, Ltd., Tokyo (JP)

(21) Appl. No.: 14/767,024

(22) PCT Filed: Oct. 2, 2013
(86) PCT No.: PCT/JP2013/076856

§ 371 Date: Aug. 11, 2015

(51) Int. Cl. H04L 29/08; H04L 12/24; H04L 29/06

(52) U.S. Cl. CPC H04L 67/1097; H04L 67/42; H04L 41/0803

(57) ABSTRACT

The present invention can shorten a response time required by a client computer to receive configuration information after transmitting a request for the configuration information to a storage system.

A storage controller updates a plurality of pieces of configuration information based on control. A server computer transmits, to a storage controller, input information designating configuration information among the plurality of pieces of configuration information, according to a preconfigured schedule. The storage controller transmits output information including the configuration information inside the storage controller to a server computer based on the input information. The server computer receives output information, and stores the output information in association with the input information. Upon receipt of the input information from a client computer, the server computer transmits the output information associated with the received input information to the client computer.

### TECHNICAL FIELD

This invention relates to a storage system.

### BACKGROUND ART

PTL 1 discloses that a management server acquires configuration information showing the structure of a storage apparatus from a control device of the storage apparatus through an SVP (Service Processor) which is an information processor for maintenance and management.

### CITATION LIST

### Patent Literature

[PTL 1]

Japanese Patent Application Laid-Open No. 2008-233973

### SUMMARY OF INVENTION

### Technical Problem

It takes time for a client computer to receive configuration information after transmitting a request for the configuration information to a storage system.

### Solution to Problem

For solving the above problem, a storage system according to an aspect of the present invention includes a storage device, a storage controller coupled to the storage device and a host computer, and a server computer coupled to the storage controller. The storage controller controls the storage device based on a command from the host computer, stores a plurality of pieces of configuration information each showing a plurality of types of configuration information in the storage system, and updates the plurality of pieces of configuration information based on control. The server computer transmits input information designating configuration information among the plurality of pieces of configuration information to the storage controller according to a preconfigured schedule. The storage controller transmits output information including the configuration information inside the storage controller to the server computer based on the input information. The server computer receives the output information and stores the output information in association with the input information. Upon receipt of the input information from a client computer, the server computer transmits the output information associated with the received input information to the client computer.

### Advantageous Effects of Invention

According to an aspect of the present invention, it is possible to shorten a response time required by a client computer to receive configuration information after transmitting a request for the configuration information to a storage system.

### BRIEF DESCRIPTION OF DRAWINGS

FIG. 1 shows a hardware configuration of a storage system of a first embodiment of the present invention.

FIG. 2 shows a software configuration of the storage system of the first embodiment.

FIG. 3 shows a configuration of a hash management table 310.

FIG. 4 shows a configuration of an output information management table 320.

FIG. 5 shows polling processing.

FIG. 6 shows management information update processing.

FIG. 7 shows configuration information provisioning processing.

FIG. 8 shows a software configuration of the storage system of a second embodiment of the present invention.

FIG. 9 shows an update management table 330.

FIG. 10 shows management information update processing of the second embodiment.

FIG. 11 shows configuration information provisioning processing.

FIG. 12 shows a display screen of a display apparatus 500.

FIG. 13 shows a measuring result of the total update frequency and the update frequency.

FIG. 14 shows an acquisition period table 830.

### DESCRIPTION OF EMBODIMENTS

Hereinafter, a configuration of the storage system according to the embodiment of the present invention will be described.

### First Embodiment

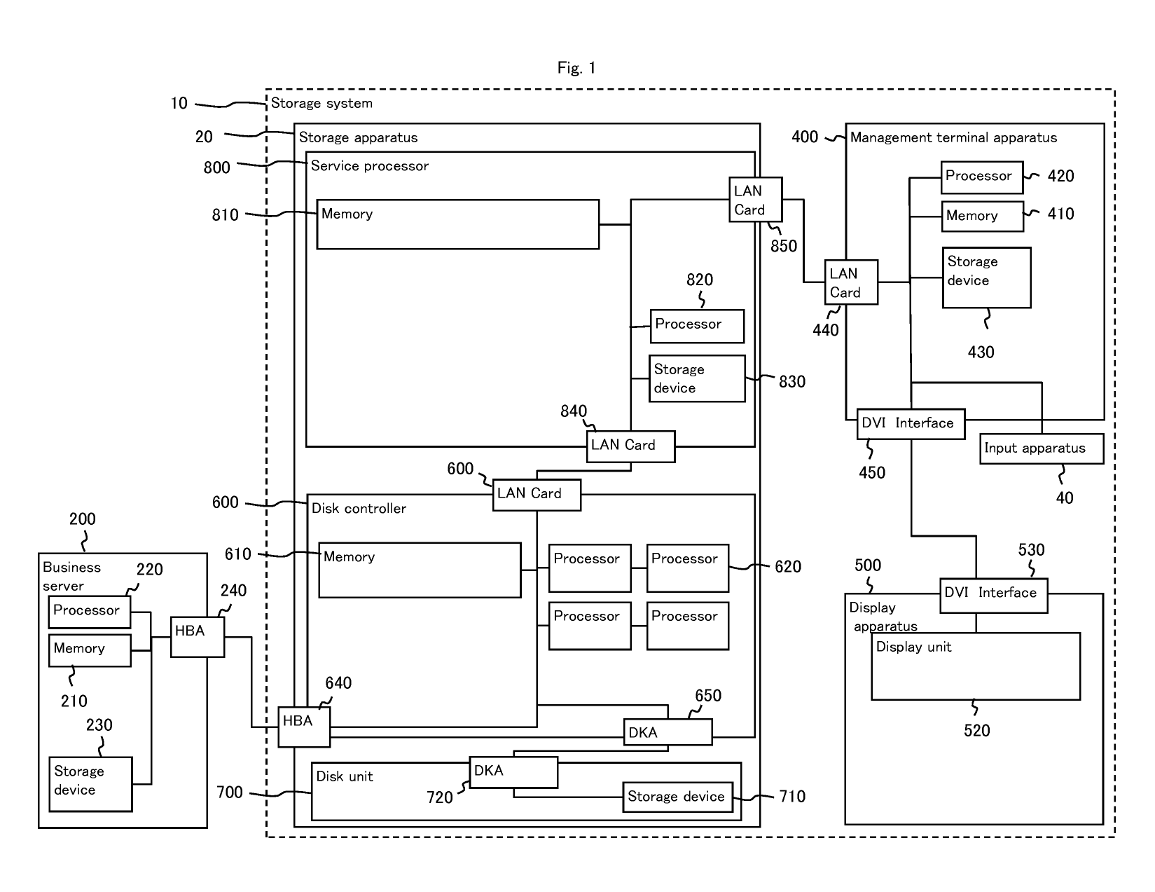

FIG. 1 shows a hardware configuration of the storage system of a first embodiment of the present invention.

A storage system 10 of the present embodiment is coupled to a host computer such as a business server 200 through a communication line such as a SAN (Storage Area Network). The storage system 10 includes a storage apparatus 20, a management terminal apparatus 400, a display apparatus 500, and an input apparatus 40. The management terminal apparatus 400 is coupled to the storage apparatus 20 through the communication line such as a LAN (local Area Network). The display apparatus 500 is coupled to the management terminal apparatus 400 through a video line such as a DVI (Digital Visual Interface). The input apparatus 40 is coupled to the management terminal apparatus 400 through a communication line such as a USB (Universal Serial Bus).

The storage apparatus 20 includes a disk controller (DKC: Disk Controller) 600, a disk unit (DKU: Disk Unit) 700, and a service processor (SVP) 800.

The disk controller 600 is coupled to the business server 200 through the communication line. The disk controller 600 includes a memory 610, a plurality of processors (MP: Microprocessor) 620, a host interface such as an HBA (Host Bus Adaptor) 640, a disk interface such as a DKA (Disk Adaptor) 650, and a communication interface such as a LAN card 660.

The memory 610 includes a cache memory for storing write data received from the business server 200 and read data transmitted to the business server 200, and a request memory for storing configuration information and the like showing a configuration of the storage apparatus 20. The memory 610 also stores a program and data for processing the disk controller 600. The processor 620 executes processing based on the program and the data inside the memory 610. The HBA 640 is coupled to the business server 200, and, for example, follows an FC (Fiber Channel). The DKA 650 is coupled to a disk unit 700, and, for example, follows a SAS (Serial Attached Small Computer System Interface) and a SATA (Serial Advanced Technology Attachment). A LAN card 660 is coupled to the service processor 800.

The disk unit 700 is coupled to the disk controller 600 through the communication line. The disk unit 700 includes a disk interface 710 and a storage device 720. The storage device 720 is, for example, an HDD (Hard Disk Drive) and an SSD (Solid State Disk), and stores user data from the business server 200.

The service processor 800 is coupled to the disk controller 600 through the communication line. The service processor 800 includes a memory 810, a processor 820, a storage device 830, a communication interface such as a LAN card 840, and a communication interface such as a LAN card 850. The memory 810 stores a program and data for the processing of the service processor 800. The processor 820 executes processing based on the program and the data inside the memory 810. The storage device 830 stores data for the management of the storage apparatus 20, and is, for example, an HDD. The LAN card 840 is coupled to the disk controller 600 through a LAN. The LAN card 850 is coupled to a management terminal apparatus 400.

The management terminal apparatus 400 includes a memory 410, a processor 420, a storage device 430, a communication interface such as a LAN card 440, and a video interface such as a DVI interface 450. The memory 410 stores a program and data for the processing of the management terminal apparatus 400. The processor 420 executes processing based on the program and the data inside the memory 410. The storage device 430 stores data for the management of the storage apparatus 20, and is, for example, an HDD. The LAN card 440 is coupled to the service processor 800 through the LAN. The DVI interface 450 is coupled to the display apparatus 500 through a DVI cable.

The display apparatus 500 includes a display unit 520, and a video interface such as a DVI interface 530. The DVI interface 530 is coupled to the management terminal apparatus 400 through the DVI cable. The display unit 520 receives display information from the management terminal apparatus 400 through the DVI interface 530, and displays a display screen based on the display information.

The business server 200 includes a memory 210, a processor 220, a storage device 230, and a host interface such as an HBA 240. The memory 210 stores a program and data for the processing of the business server 200. The processor 220 executes processing based on the program and the data inside the memory 210. The storage device 230 is, for example, an HDD, and stores data for the business of the business server 200. The HBA 240 is coupled to the storage apparatus 20.

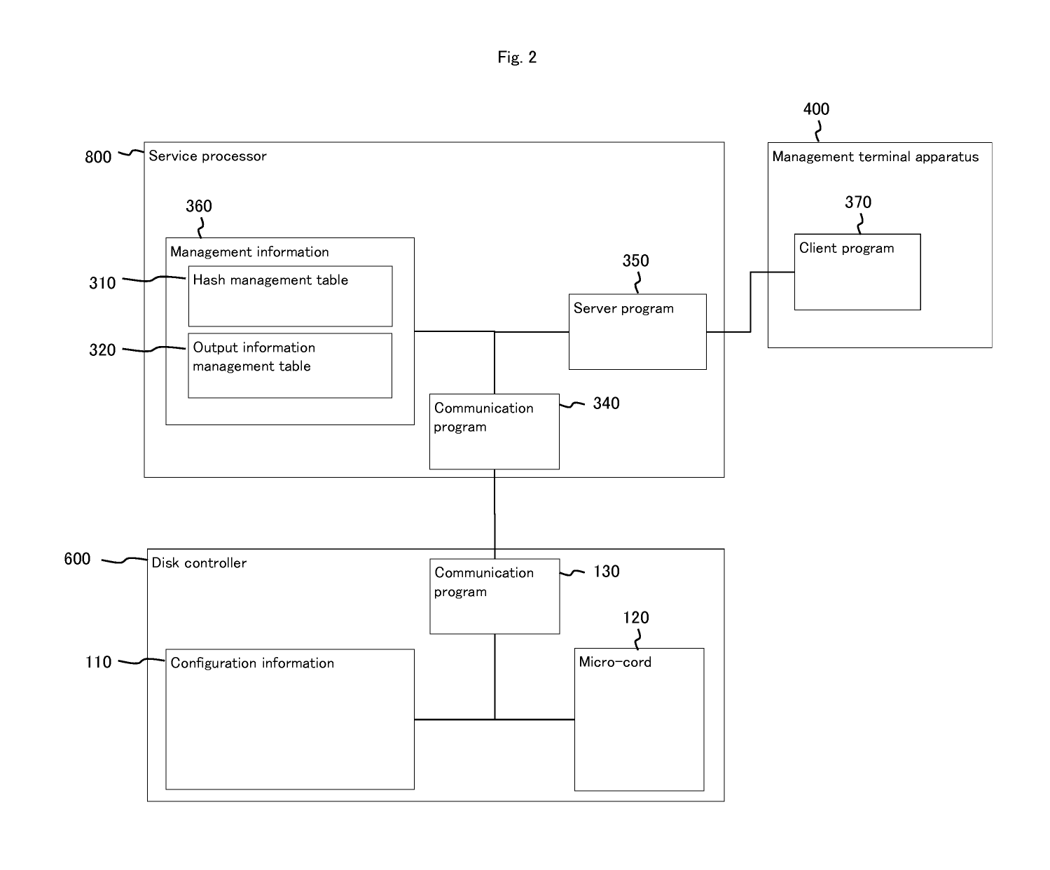

FIG. 2 shows a software configuration of the storage system of the first embodiment.

The memory 610 of the disk controller 600 stores configuration information 110, a micro-code 120, and a communication program 130. The micro-code 120 is a program for controlling the disk controller 600. The communication program 130 is a program for communicating with the service processor 800.

The memory 810 of the service processor 800 stores a communication program 340, a server program 350, and management information 360. A communication program 330 is a program for communicating with the disk controller 600. The server program 350 is a program for communicating with a management terminal apparatus 400, and is, for example, a web server program including an RMI (Remote Method Invocation) server. The management information 360 includes a hash management table 310 and an output information management table 320. The hash management table 310 stores a hash value of input information inputted to the disk controller 600 in association with a hash value of output information outputted from the disk controller 600. The output information management table 320 stores the hash value of output information in association with output information. The management information may be stored in other storage devices such as an HDD and an SSD.

The memory 410 of the management terminal apparatus 400 stores a client program 370. The client program 370 is a program for communicating with the server program 350 of the service processor 800, and is, for example, a web browser program including the RMI client.

Hereinafter, a plurality of pieces of configuration information which is displayed by the display apparatus 500 among the plurality of pieces of configuration information stored in the memory 610 of the disk controller 600 will be referred to as a configuration information group.

Hereinafter, the management information will be described.

Input information is an object which is transmitted to the disk controller 600 from the service processor 800. The input information is, for example, an object showing a function in which a specific kind of the configuration information among the configuration information group is acquired from the disk controller 600. The input information may include a parameter such as a function name and an argument of the function. For example, the object of the input information includes a function name and a logical device number when a function acquiring logical device information having a specific logical device number POOLgetAOUVolRelation_IN (Logical device number) is used.

Input information may be a function by which the configuration information of a specific kind is configured for the disk controller 600.

Output information is an object transmitted from the disk controller 600 to the service processor 800 in response to the input information transmitted from the service processor 800 to the disk controller 600. The output information is, for example, configuration information. The output information may include a function name of the corresponding input information and a parameter of the input information. For example, an object of the output information acquired by the function POOLgetAOUVolRelation_IN (Logical device number) includes a function name, a logical device number, a pool number (ID) including a physical memory area allocated to the logical device, a capacity of the logical device (DP Vol: Dynamic Provisioning Volume), a using amount of the logical device, and the like. Further, the object of the output information may include information such as a threshold value of the using amount which is configured for the disk controller 600 through the service processor 800 from the management terminal apparatus 400.

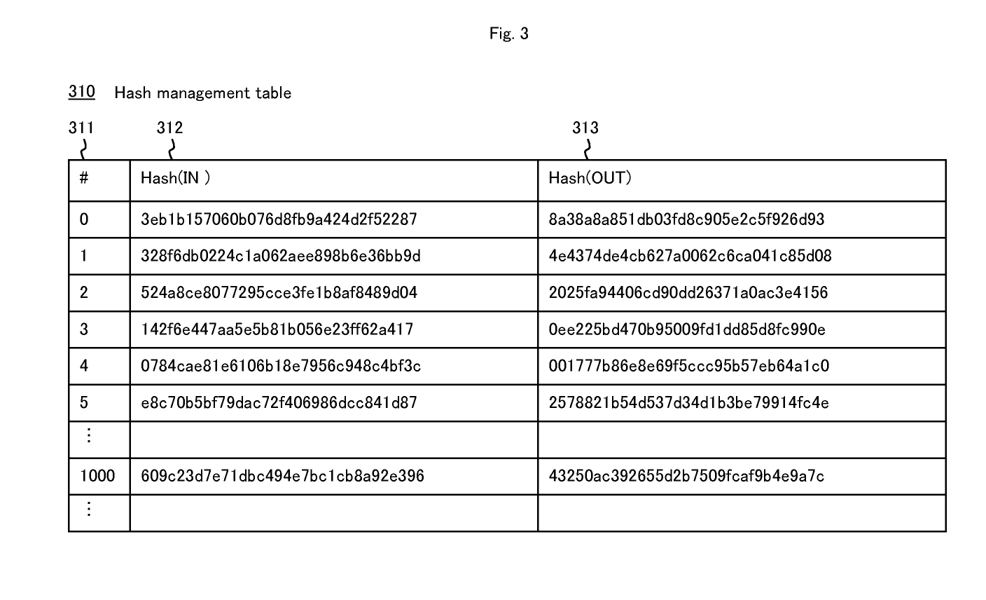

FIG. 3 shows a configuration of the hash management table 310.

The hash management table 310 includes an entry for each piece of mutually different input information. Each entry includes the number (#) 311 of the input information, an input information hash value (Hash (IN)) 312 which is a hash value of the input information, and an output information hash value (Hash (OUT)) 313 which is a hash value of the output information outputted from the disk controller 600 according to the input information.

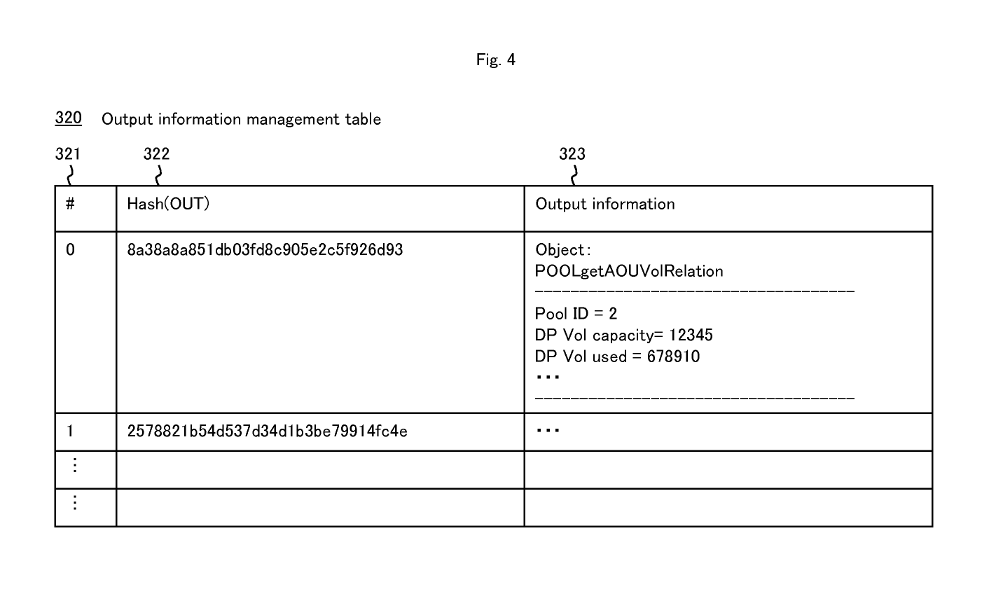

FIG. 4 shows a configuration of the output information management table 320.

The output information management table 320 includes an entry for each piece of mutually different output information. Each entry includes an output information number (#) 321, an output information hash value (Hash (OUT)) 322 which is a hash value of the output information, and output information 323.

Hereinafter, the operation of a service processor 800 will be described.

The service processor 800 executes polling processing which periodically acquires the configuration information group from the disk controller 600. In the polling processing, the service processor 800 transmits the input information showing a function for acquiring the configuration information group to the disk controller 600, thereby acquiring the configuration information group from the disk controller 600.

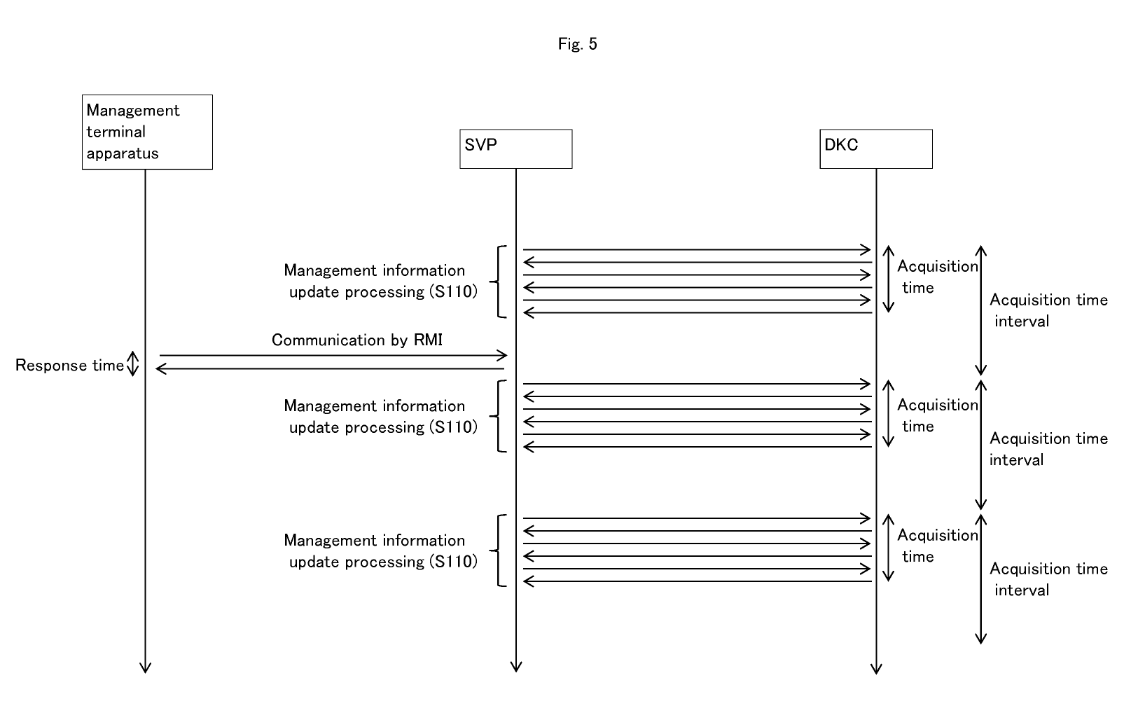

FIG. 5 shows polling processing.

The service processor 800 executes management information update processing (S110). In the management information update processing, the service processor 800 transmits the input information for acquiring the configuration information to the disk controller 600 for each piece of the configuration information inside the configuration information group, receives the configuration information from the disk controller 600, and updates management information based on the received configuration information. The details of the management information update processing will be described later. The disk controller 600 having received the input information transmits the configuration information designated by the input information to the service processor 800.

Thereafter, the service processor 800 executes the management information update processing each time a predetermined acquisition period elapses from the execution of the previous management information update processing (S110). This acquisition period is longer than the acquisition time necessary for the service processor 800 to acquire the configuration information group from the disk controller 600 by the management information update processing. For example, when the acquisition time is three minutes, the acquisition period is defined as five minutes.

According to the polling processing, the service processor 800 can update the configuration information group inside the memory 810 for each acquisition period.

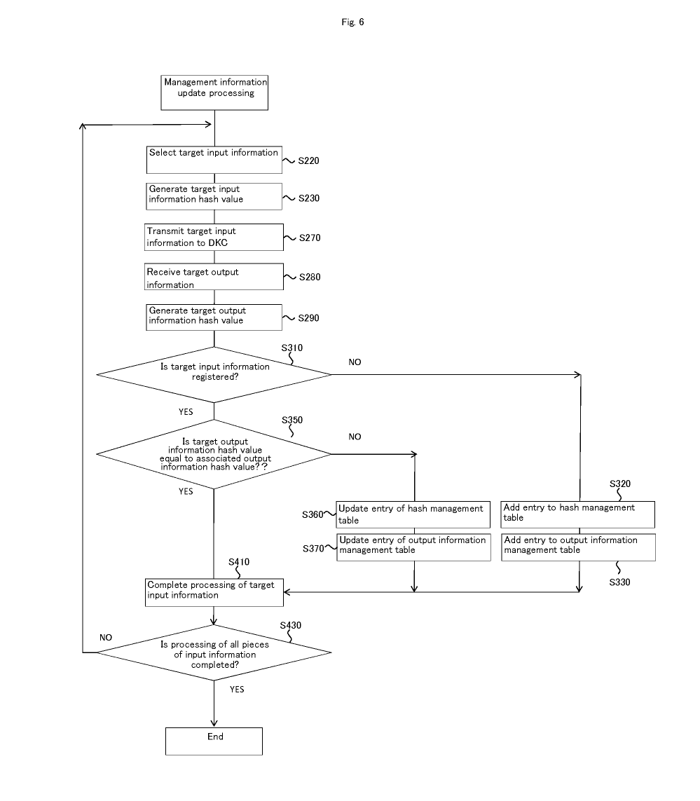

FIG. 6 shows management information update processing.

The service processor 800 may preliminarily store the input information group in the memory 810, and may generate the input information group corresponding to the configuration information group based on a preset rule. One piece of the input information is selected as target input information according to the predetermined number among the input information groups (S220). Thereafter, the service processor 800 generates a hash value of the target input information as a target input information hash value using a hash function (S260). Thereafter, the service processor 800 transmits the target input information to the disk controller 600 (S270). The disk controller 600 having received the target input information reads the configuration information designated by the target input information from the memory 610 by executing the processing of the target input information, and generates output information including a read result so as to be transmitted to the service processor 800.

Thereafter, the service processor 800 receives the output information from the disk controller 600 as target output information (S280). Thereafter, the service processor 800 generates a hash value of the target output information as a target output information hash value using the hash function (S290).

Thereafter, the service processor 800 determines whether the target input information hash value is registered in the hash management table 310 (S310).

When the target input information hash value is not registered in the hash management table 310 (S310: NO), the service processor 800 updates the hash management table 310 by adding an entry including the target input information hash value and the target output information hash value to the output information management table 310 (S320). Further, the service processor 800 updates the output information management table 320 by adding an entry including the target output information and the target output information hash value to the output information management table 320 (S330), and moves the processing to step S410.

When the target input information hash value is registered in the hash management table 310 (S310: YES), the service processor 800 sets the output information hash value associated with the target input information hash value as an associated output information hash value in the hash management table 310, and determines whether the target output information hash value is equal to the associated output information hash value (S350).

When the target output information hash value is different from the associated output information hash value (S350: NO), the service processor 800 changes the associated output information hash value into the target output information hash value in the hash management table 310 so that the hash management table 310 is updated (S360). Further, the service processor 800 changes an entry of the associated output information hash value into the target output information hash value and the target output information in the output information management table 320 so that the output information management table 320 is updated (S370), and moves the processing to step S410.

When the target output information hash value is equal to the associated output information hash value (S350: YES), the service processor 800 moves the processing to step S410.

After step S330, after step S370, or after determined YES at step S350, the service processor 800 completes the processing of the target input information (S410), and determines whether the processing of all pieces of the input information is completed (S430).

When the processing of all pieces of the input information is not completed (S430: NO), the service processor 800 moves the processing to step S220, and selects the next input information.

When the processing of all pieces of the input information is completed (S430: YES), the service processor 800 completes this flow.

According to the management information update processing, the service processor 800 receives the configuration information of the pre-specified type from the disk controller 600, and can update the management information inside the memory 810 based on the received configuration information.

The service processor 800 executes configuration information provisioning processing in which the configuration information requested from the management terminal apparatus 400 is transmitted to the management terminal apparatus 400. The server program 350 of the service processor 800 provides an object, and the client program 370 of the management terminal apparatus 400 calls a method (function) of the object using the RMI so that the configuration information can be acquired. Further, the service processor 800 calculates the hash value of the output information, and can determine promptly whether the output information stored in the service processor 800 is updated by comparing the hash value of the output information with the hash value stored in the service processor 800.

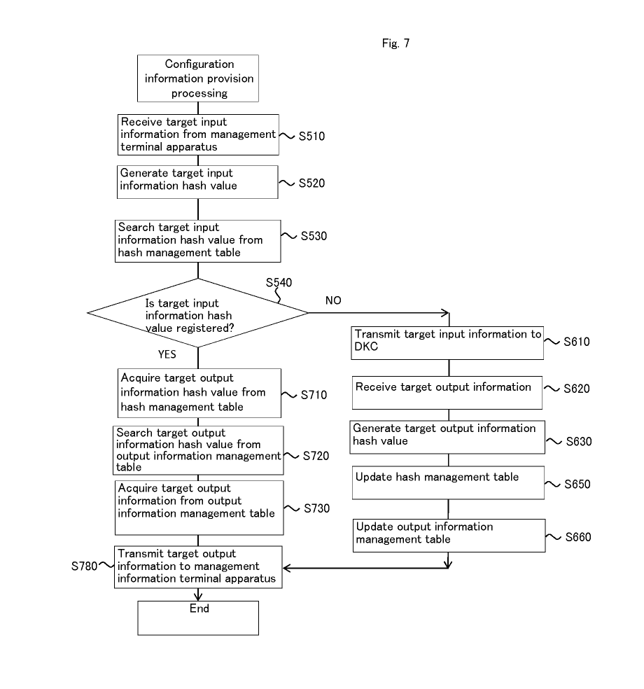

FIG. 7 shows a configuration information provisioning processing.

When the management terminal apparatus 400 calls a function which acquires configuration information using the RMI, a service processor 800 acquires the received information as target input information (S510). Thereafter, the service processor 800 generates a hash value of the target input information as a target input information hash value (S520), and searches the target input information hash value from a hash management table 310 (S530). Hereinafter, the service processor 800 determines whether the target input information hash value is registered in the hash management table 310 (S540).

When the target input information hash value is not registered in the hash management table 310 (S540: NO), the service processor 800 transmits the target input information to a disk controller 600 (S610). Here, the service processor 800 interrupts the management information update processing when the management information update processing is being executed. The disk controller 600 having received the target input information generates output information based on the target input information so as to be transmitted to the service processor 800.

Thereafter, the service processor 800 receives the output information from the disk controller 600 as target output information (S620). Thereafter, the service processor 800 generates a hash value of the target output information as an target output information hash value (S630). Thereafter, the service processor 800 updates the hash management table 310 by adding an entry including the target input information hash value and the target output information hash value to the output information management table 310 (S650). Moreover, the service processor 800 updates the output information management table 320 by adding an entry including the target output information and the target output information hash value to the output information management table 320 (S660), and moves the processing to step S780. Here, the service processor 800 may not perform the update of the hash management table 310 and the output information management table 320, but may perform the update of the hash management table 310 and the output information management table 320 at the polling time.

When the target input information hash value is registered in the hash management table 310 (S540: YES), the service processor 800 acquires an output information hash value associated with the object information hash value in the hash management table 310 as an target output information hash value (S710). Thereafter, the service processor 800 searches the output information hash value from the output information management table 320 (S720). Thereafter, the service processor 800 acquires the output information associated with the target output information hash value from the output information management table 320 as target output information (S730).

Thereafter, the service processor 800 transmits the target output information to the management terminal apparatus 400 as a response (S780), and completes this flow.

According to the above-described configuration information provisioning processing, when the function and the configuration information called by the management terminal apparatus 400 are stored in the service processor 800, because the service processor 800 is not required to transmit the stored configuration information to the management terminal apparatus 400 and to acquire the configuration information from the disk controller 600, the response time of the function call by the management terminal apparatus 400 can be shortened. Even when a plurality of function calls for acquiring a plurality of pieces of configuration information is performed by the management terminal apparatus 400, in the case that a part of those pieces of configuration information is stored in the service processor 800, the service processor 800 is not required to acquire all the configuration information groups from the disk controller 600 because the stored configuration information is transmitted to the management terminal apparatus 400. As a result, the response time of the function call by the management terminal apparatus 400 can be shortened. Further, the service processor 800 calculates a hash value of the input information, and can determine promptly whether the input information is stored in the service processor 800 by comparing the hash value of the input information with the hash value stored in the service processor 800.

### Second Embodiment

The configuration of a storage system 10 of the present embodiment is the same as that of the first embodiment. The storage system 10 of the present embodiment updates management information taking into consideration of the load of a disk controller 600, the update frequency of configuration information, and the like.

The hardware configuration of the storage system of the second embodiment is the same as that of the first embodiment.

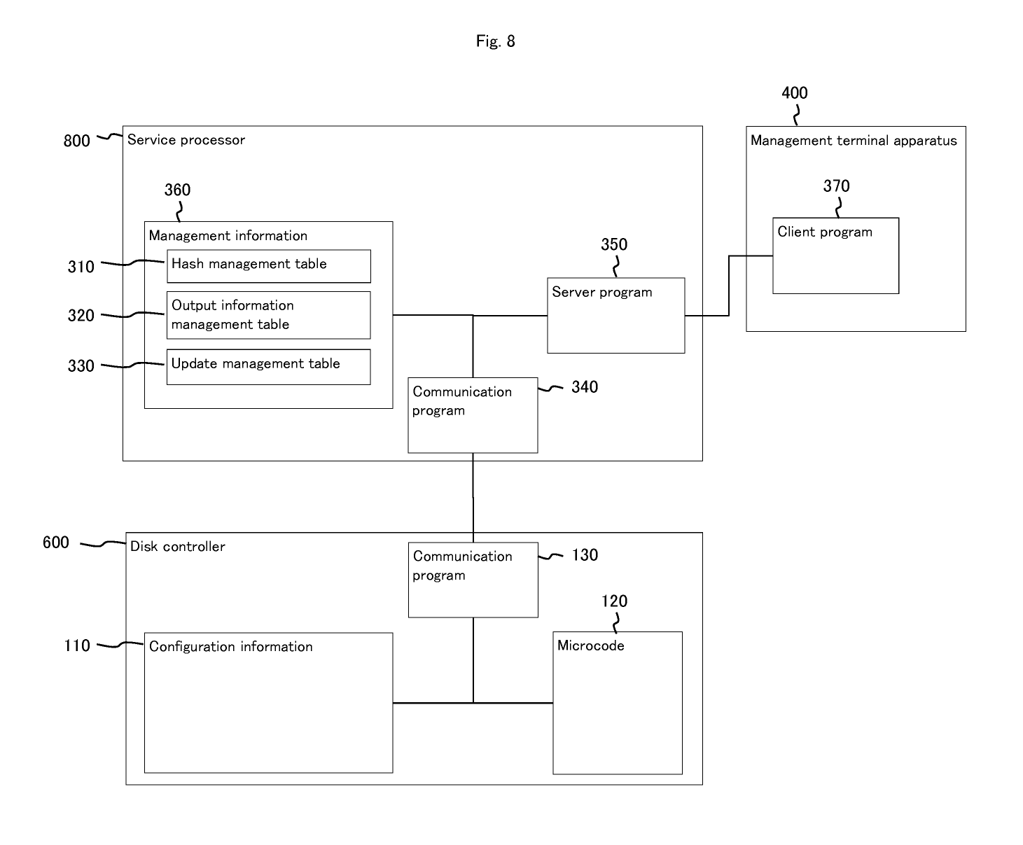

FIG. 8 shows a software configuration of the storage system of the second embodiment.

A disk controller 600 transmits status information such as an error code showing its status to a service processor 800 when an anomaly occurs. For example, the status information shows that the usage rate of a processor 620 of the disk controller 600 becomes equal to or larger than a prescribed usage rate threshold value and that anomaly has occurred in a cache memory in a memory 610 or the like.

A memory 810 of the service processor 800 of the present embodiment further stores an update management table 330 for managing update frequency and an output information acquisition time. The management information of the present embodiment further includes an update management table 330. The service processor 800 counts the update frequency which is the number of times output information is updated for each type of the configuration information and for each measurement period of the predetermined time length so as to be stored in the update management table 330. The service processor 800 further stores the time by which each output information is acquired as an output information acquisition time in the update management table 330.

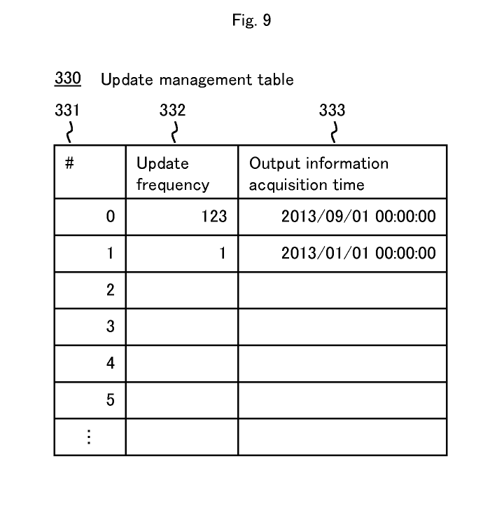

FIG. 9 shows an update management table 330.

The update management table 330 includes an entry for each piece of input information. Each entry includes the number (#) 331 of the input information in the input information group, an update frequency 332 of the input information counted in the immediately before measuring period, and an output information acquisition time 333 which is the time in which the output information corresponding to the input information is lastly acquired from the disk controller 600.

Hereinafter, the operation of the service processor 800 of the present embodiment will be described.

Configuration information provisioning processing is the same as that of the first embodiment.

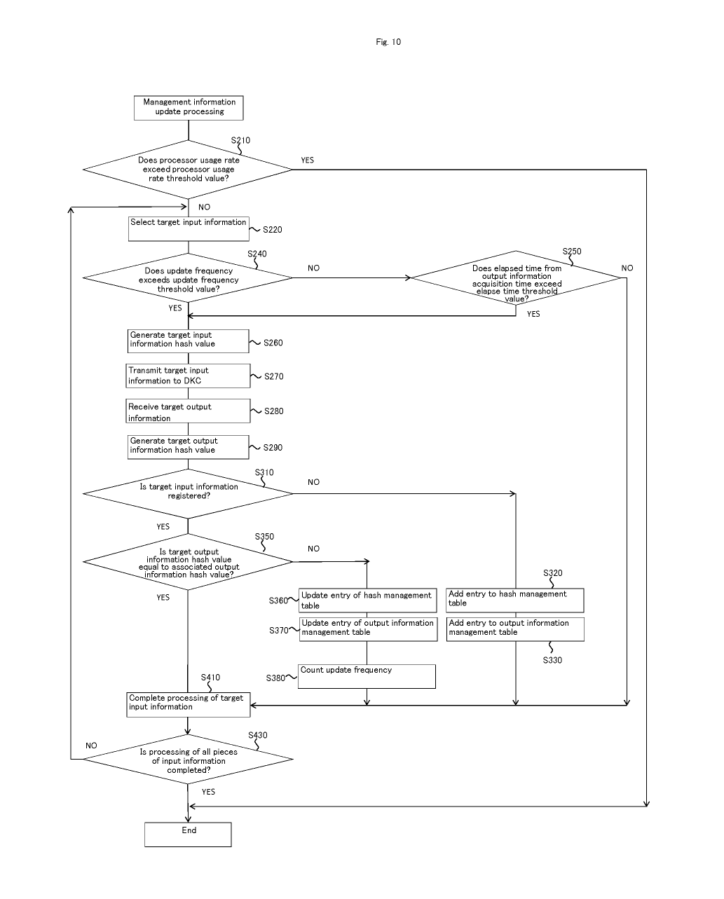

FIG. 10 shows management information update processing of the second embodiment.

In the management information update processing of the second embodiment, an element attached with the same reference numeral as that of the element of the management information update processing of the first embodiment is the same element of the management information update processing of the first embodiment.

The service processor 800 determines whether a usage rate of the processor 620 of the disk controller 600 exceeds a usage rate threshold value based on the status information (S210). Here, the service processor 800 may determine whether an anomaly of the disk controller 600 occurs by using other status information such as the anomaly of a cache memory of the disk controller 600.

When it is determined that the usage rate of the processor 620 exceeds the usage rate threshold value (S210: YES), the service processor 800 completes this flow without acquiring the configuration information from the disk controller 600.

When it is determined that the usage rate of the processor 620 does not exceed the usage rate threshold value (S210: NO), the service processor 800, similarly to the first embodiment, selects target input information (S220). Thereafter, the service processor 800 acquires update frequency corresponding to the number of target input information from the update management table 330, and determines whether the update frequency measured in the immediate before measuring period exceeds a predetermined update frequency threshold value (S240).

When the update frequency does not exceed the update frequency threshold value (S240: NO), the service processor 800 determines whether an elapsed time from an output information acquisition time corresponding to the target input information exceeds a predetermined elapse time threshold value (S250).

When it is determined that the elapse time does not exceed the elapse time threshold value (250: NO), the service processor 800 moves the processing to the same step S410 as that of the first embodiment.

When it is not determined that the elapse time exceeds the elapse time threshold value (S250: YES), the service processor 800 performs processing from step S260 onward similarly to the first embodiment.

After step S370, the service processor 800 counts update frequency by adding 1 to the update frequency (S380), and moves the processing to step S410 similarly to the first embodiment.

For example, the acquisition period is defined as five minutes, the length of the measurement period is defined as one month, the update frequency threshold value is defined as 100 times, and the elapse time is defined as one hour.

According to the management information update processing, the service processor 800 does not acquire the configuration information from the disk controller 600 when it is determined that a load of the disk controller 600 is higher than a predetermined reference. As a result, performance degradation of the disk controller 600 can be prevented. Further, the service processor 800 measures the update frequency of output information for each piece of input information, and can determine whether the configuration information can be acquired from the disk controller 600 based on the measured update frequency. As a result, the configuration information can be prevented from being acquired more than necessary from the disk controller 600, and a load given to the disk controller 600 by polling can be suppressed. The service processor 800 can measure the update frequency by updating the output information when an output information hash value generated from the output information is different from the stored value. Further, the service processor 800 stores an update time of output information for each piece of input information and can determine whether the configuration information is acquired from the disk controller 600 based on an elapsed time from the update time. As a result, the configuration information can be prevented from being acquired more than necessary from the disk controller 600, and a load given to the disk controller 600 by polling can be suppressed.

The service processor 800 executes configuration information group provisioning processing to be transmitted to the management terminal apparatus 400 by acquiring all the configuration information groups from the disk controller 600 when the latest request of the configuration information group is received from the management terminal apparatus 400.

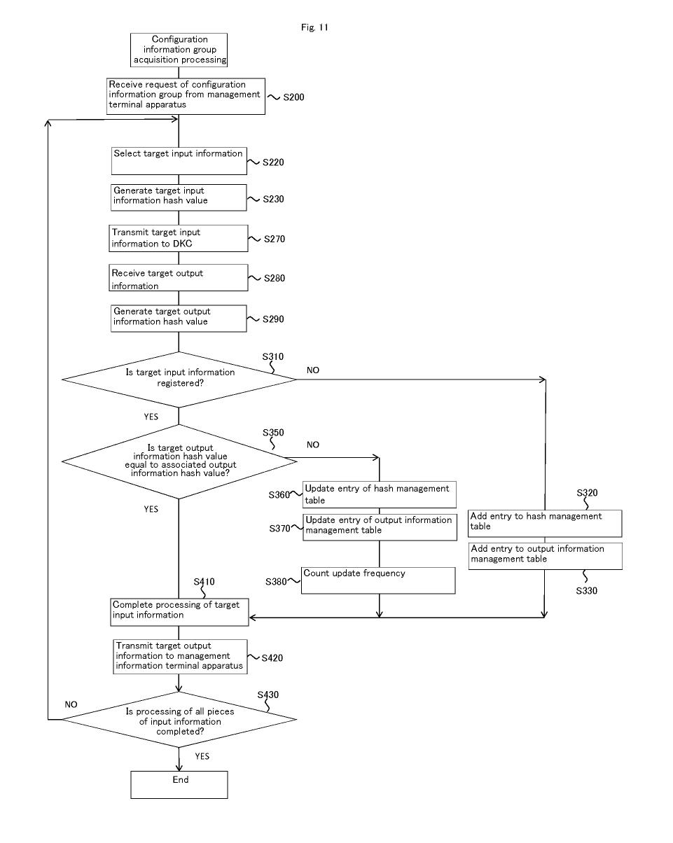

FIG. 11 shows configuration information group provisioning processing.

In the configuration information group provisioning processing, elements attached with the same reference numerals as the elements of the management information update processing are the same elements as the elements of the management information update processing.

A service processor 800 receives a plurality of pieces of input information corresponding to configuration information groups from a management terminal apparatus 400 by calling a function for acquiring the configuration information group using an RMI by the management terminal apparatus 400 (S200). Here, the service processor 800 interrupts the management information update processing when its execution is under way. Thereafter, the service processor 800 executes processing of step S220 and processing after step S260 onward similarly to the management information update processing.

After step S410, the service processor 800 transmits the target output information to the management terminal apparatus 400 as a response to the call (S420), and executes processing after step 430 onward similarly to the management information update processing.

According to the configuration information provisioning processing, the service processor 800 can acquire a plurality of pieces of configuration information from the disk controller 600 in response to a request from the management terminal apparatus 400. The management terminal apparatus 400 acquires a plurality of pieces of latest configuration information so as to be displayed in the display apparatus 500.

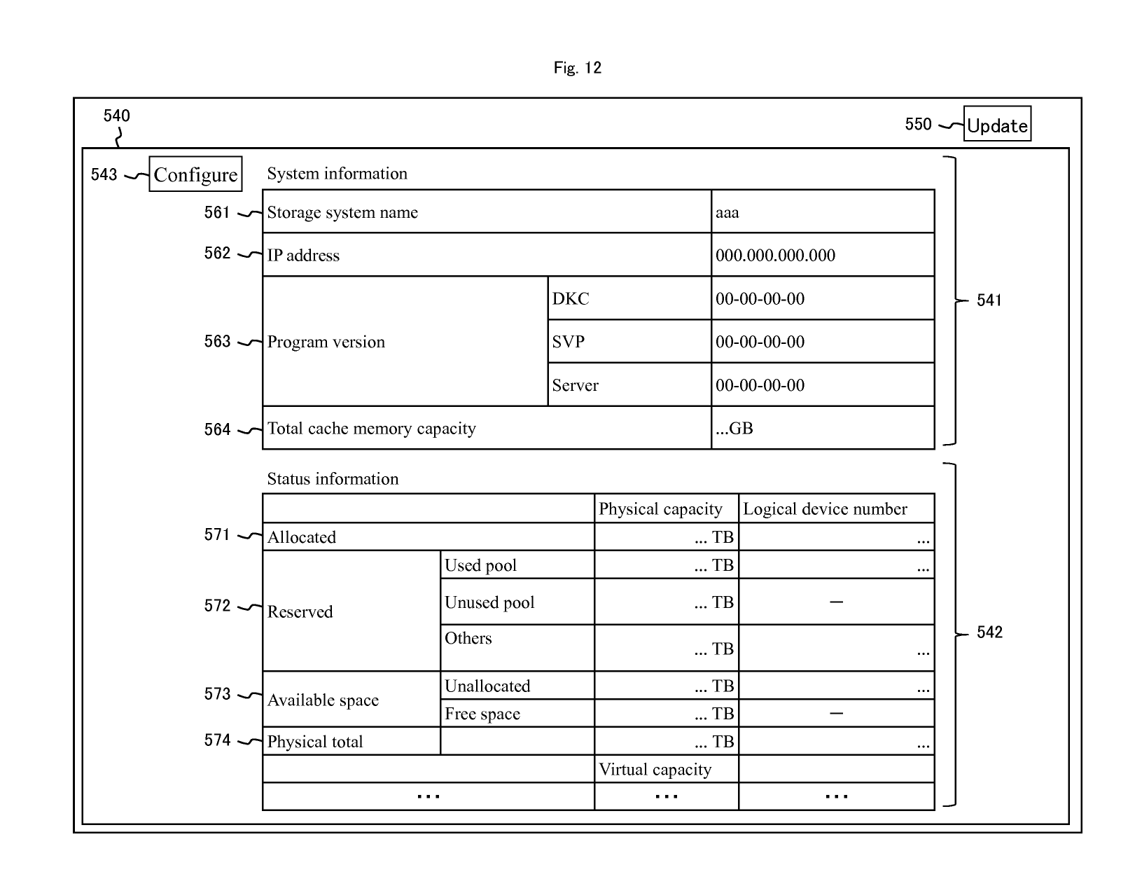

FIG. 12 shows a display screen of the display apparatus 500.

This display screen includes a configuration information display unit 540, and a configuration information group update button 550. The configuration information display unit 540 shows the configuration information which the management terminal apparatus 400 receives from the service processor 800. The configuration information group update button 550 is a button for updating all the configuration information groups. When a user of the management terminal apparatus 400 presses down the configuration information group update button 550 by an input to an input apparatus 40, the management terminal apparatus 400 transmits a function requesting for the configuration information group to the service processor 800 by using the RMI. As a result, the service processor 800 executes the above-described configuration information group provisioning processing.

The configuration information display unit 540 includes a system information display unit 541, a status information display unit 542, and a system information editing button 543. The system information display unit 541 shows system information which is information of the storage system 10 among the configuration information groups. The status information display unit 542 shows status information, which is information showing a status on a variety of storage capacities or the like inside the storage system among the configuration information groups. The system information editing button 543 is a button for configuring the system information. When the user of the management terminal apparatus 400 presses down the system information editing button 543 by the input to the input apparatus 40, the management terminal apparatus 400 transmits a function for configuring the system information to the service processor 800.

The system information, for example, includes a storage system name 561, an IP (Internet Protocol) address 562, a program version 563, a total cache memory capacity 564, and the like. The storage system name 561 shows information which identifies the storage system 10. The IP address 562 shows an IP address assigned to the storage system 10. The program version 563 shows a version such as a control program of the disk controller 600, a control program of the service processor 800, and a server program 350. The total cache memory capacity 564 shows a capacity of the total cache memories inside the storage system 10.

The status information, for example, includes an allocated (Allocated) 571, a reserved (Reserved) 572, an available space (Available Space) 573, and a physical total 574 and the like with respect to a physical capacity. The Allocated 571 shows a capacity allocated to a logical device, and a logical device number of the logical device. The Reserved 572 shows a capacity of used DP (Dynamic Provisioning or Thin Provisioning) pool, a logical device number, a capacity of an unused DP pool, other capacities, the number of logical devices and the like. The available space 573 shows a capacity unallocated to the logical device and the number of logical devices, a capacity of free space and the like. The physical total 574 shows a total of the physical capacities and the number of logical devices inside the storage system. The status information may further include information on a virtual capacity. The update frequency of the status information is higher than the update frequency of the system information.

The management terminal apparatus 400 may switch a plurality of display screens in response to the input from the user. The display screen may include a button for acquiring a specific type of configuration information from the disk controller 600. In this case, the service processor 800 may acquire the specific type of information from the disk controller 600 so as to be transmitted to the management terminal apparatus 400 similarly to the configuration information group provisioning processing.

According to this display screen, the user of the management terminal apparatus 400 can review the management information of the storage system 10. Further, the user of the management terminal apparatus 400 can cause the latest configuration information group to be displayed on the display device.

Hereinafter, a modified embodiment of the storage system 10 will be described below.

Note that the disk controller 600 may count update frequency for each type of the configuration information. In this case, the disk controller 600 transmits the update frequency to the service processor 800. In this case, the update frequency is not a frequency where the management information of the service processor 800 is updated, but may display the frequency where the configuration information inside the memory 610 of the disk controller 600 is updated.

In the management information update processing, the service processor 800 may measure a total number of update frequencies which is the number of update frequencies from the operation start for each type of the configuration information and the update frequency for each measuring period.

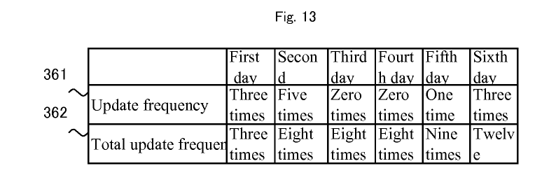

FIG. 13 shows a measurement result of the total number of update frequencies and the update frequency.

A service processor 800 measures an update frequency 361 and a total number of updates 362 for each type of the configuration information and for each measuring period. The measuring period here is one day. The service processor 800 may determine whether management information is updated based on the latest update frequency 361 and the total number of updates 362. For example, in a holiday of the business using the business server 200, even when a total number of updates of some information exceeds a predetermined total number of update threshold values, there are cases where the update frequency does not exceed the predetermined update frequency threshold value. In such cases, the service processor 800 does not acquire the configuration information from the disk controller 600.

The service processor 800 may update the management information at the time when the load of the disk controller 600 is lower than a predetermined load threshold value.

The acquisition period in the polling processing may be configured for each type of the configuration information. In this case, the service processor 800 executes the management information update processing for each type of the configuration information at the configured acquisition period. Further, a plurality of types of configuration information is divided into a plurality of groups, and the acquisition period may be configured for each group. In this case, the service processor 800 may store an acquisition period management table 830 for managing the acquisition period in the memory 810.

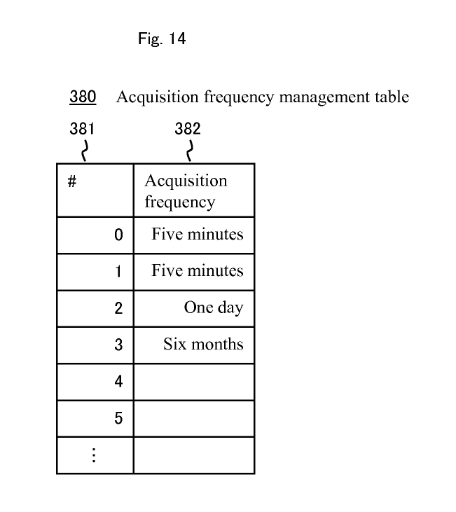

FIG. 14 shows an acquisition period management table 830.

The acquisition period management table 830 includes an entry for each piece of input information. Each entry includes a number (#) 381 of the input information in the input information group, and an acquisition period 382. A service processor 800 transmits the input information to a disk controller 600 for each acquisition period corresponding to the input information based on the acquisition period management table 830. By configuring the acquisition period for each type of the configuration information, a load added to the disk controller 600 can be suppressed.

For example, the configuration information group may be divided into status information and system information. The status information is frequently changed by the disk controller 600, whereas the system information is hardly changed after it is configured. Consequently, the acquisition period of the system information is longer than the acquisition period of the status information. For example, the acquisition period of the status information is five minutes, whereas the acquisition period of the system information is one day. The configuration information which makes the acquisition period shortest is, for example, an LDEV (Logical Device) usage amount showing the usage amount of a logical device, a processing progress rate showing a progress rate of processing by the disk controller 600, a task screen showing a task by the disk controller 600, and the like.

Further, the system information may be divided into software configuration information showing a structure of software and hardware configuration information showing the structure of hardware. The acquisition period of the hardware configuration information is longer than the acquisition period of the software configuration information. For example, the acquisition period of the software configuration information is one day, and the acquisition period of the hardware configuration information is six months. The software configuration information is, for example, information showing the configuration of a pool, information showing the configuration of a pair of volumes for a copy, user management information showing users, and a Tiering Policy showing the policy of a hierarchical storage. The hardware configuration information is, for example, information showing a parity group, information showing a cache memory, and information showing a port.

Further, the configuration information may be divided into DKC change information which is changed triggered by the disk controller 600 and SVP change information which is changed triggered by the service processor 800. The service processor 800 acquires the DKC change information from the disk controller 600 by a function for acquiring the configuration information. The DKC change information is, for example, status information. The service processor 800 configures the SVP change information to the disk controller 600 by a function for configuring the configuration information. The SVP change information is, for example, the system information.

The service processor 800 analyzes a change of the update frequency for each type of the configuration information and for each measuring period, and may configured an acquisition period based on the analytic result. For example, the service processor 800 records a time change of the update frequency over a plurality of measuring periods for each type of the configuration information, calculates a frequency component of the time change of the update frequency by Fourier transformation, and determines the acquisition period based on the frequency component. As a result, the optimum acquisition period can be configured for each type of the configuration information.

Some embodiments from among the embodiments and the modified embodiment as described above may be combined.

Terms in the storage system according to an aspect of the present invention will be described. The storage controller corresponds to the disk controller 600 and the like. The server computer corresponds to the service processor 800 and the like. The client computer corresponds to the management terminal apparatus 400 and the like.

Note that, according to the above description, though the information of the present invention is explained by the expression such as [aaa table], [aaa list], [aaa DB], and [aaa Cue], these pieces of the information may be expressed by other than a data structure such as a table, a list, a DB, and a Cue. For this reason, [aaa Table], [aaa List], [aaa DB], [aaa Cue] and the like may be called [aaa Information] in order to show that they do not depend on the data structure.

Further, when the content of each piece of the information is explained, the expression such as [identification information], [identifier], [prename], [name], and [ID] is used. However, these expressions can be replaced with each other.

Further, though the explanation may be made by using a “program” as a subject, because the program performs processing defined by being executed by the processor using the memory and the communication port, the explanation may be made with the processor defined as a subject. Further, the processing disclosed with the program as a subject may be defined as the processing performed by a management computer or information processor. Further, apart or all of the program may be realized by exclusive hardware.

Further, various programs may be installed in each computer by a program distribution server and a storage medium readable by the computer.

### REFERENCE SIGNS LIST

10 Storage system
20 Storage apparatus
110 Configuration information
200 Business server
310 Hash management table
320 Output information management table
330 Update management table
400 Management terminal device
410 Memory
420 Processor
430 Storage device
500 Display device
600 Disk controller
610 Memory
620 Processor
700 Disk unit
800 Service processor
810 Memory
820 Processor

1. A storage system comprising:
a storage device;
a storage controller coupled to the storage device and a host computer; and
a server computer coupled to the storage controller,
wherein the storage controller is configured to control the storage device based on a command from the host computer, store a plurality of pieces of configuration information each showing a plurality of types of configurations in the storage system, and update the plurality of pieces of configuration information based on the control,
the server computer is configured to transmit, to the storage controller, input information designating configuration information among the plurality of pieces of configuration information according to a preconfigured schedule,
the storage controller is configured to transmit, to the server computer, output information including the configuration information inside the storage controller based on the input information,
the server computer is configured to receive the output information, and store the output information in association with the input information, and
the server computer is configured to transmit, upon receipt of the input information from a client computer, output information associated with the received input information to the client computer.

2. The storage system according to claim 1, wherein the server computer is configured to calculate a hash value of the input information as an input information hash value, calculate a hash value of the output information received according to the input information as an output information hash value, and store the input information hash value, the output information hash value, and the output information in association with each other, and
the server computer is configured to calculate a hash value of the received input information, and when an input information hash value equal to the calculated hash value is stored, transmit the output information associated with the input information hash value to the client computer.

3. The storage system according to claim 2, wherein the server computer is configured to transmit the input information to the storage controller at a predetermined period, and receive the output information from the storage controller.

4. The storage system according to claim 3, wherein the storage controller is configured to transmit load information showing a load of the storage controller to the server computer, and
the server computer is configured to determine whether to transmit the input information to the storage controller based on the load information.

5. The storage system according to claim 4, wherein the server computer is configured to measure an update frequency of output information stored in the server computer within a predetermined measuring period, and determine whether to transmit the input information to the storage controller based on the update frequency.

6. The storage system according to claim 5, wherein the server computer is configured to transmit, to the storage controller, target input information which is input information corresponding to each of the plurality of pieces of configuration information according to a preconfigured schedule, calculate a hash value of target output information received according to the transmission of the target input information as a calculated hash value, and when an target output information hash value which is an output information hash value associated with the target input information is different from the calculated hash value, change the target output information hash value to the calculated hash value, change output information associated with the target input information to the target output information, and increase update frequency associated with the target input information.

7. The storage system according to claim 6, wherein the server computer is configured to store time when the server computer receives output information from the storage controller, and determine whether to transmit the input information to the storage controller based on an elapse time from the time.

8. The storage system according to claim 3, wherein the server computer is configured to determine an acquisition period for each of the plurality of pieces of configuration information and transmit the input information to the storage controller at the acquisition period.

9. The storage system according to claim 3, wherein the server computer is configured, when a configuration information group request which requires a plurality of pieces of latest configuration information is received from the client computer, to transmit a plurality of pieces of input information corresponding to each of the plurality of pieces of configuration information to the storage controller based on the configuration information group request,
the storage controller is configured to transmit, to the server computer, a plurality of pieces of output information respectively including the plurality of pieces of configuration information based on the plurality of pieces of input information, and
the server computer is configured to receive the plurality of pieces of output information, and transmit the received plurality of pieces of output information to the client computer.

10. The storage system according to claim 9, further comprising the client computer,
wherein the client computer is configured to transmit the input information to the server computer, receive the output information from the server computer, and cause information based on the output information to be displayed on a display device.

11. The storage system according to claim 10, wherein the client computer is configured to transmit the configuration information group request to the server computer based on an input from a user.

12. A storage system control method comprising:
using a storage controller coupled to a storage device and a host computer to control the storage device based on a command from the host computer, to store a plurality of pieces of configuration information each showing a plurality of types of configurations in a storage system including the storage device, and to update the plurality of pieces of configuration information based on the control;
using a server computer coupled to the storage controller to transmit, to the storage controller, input information designating configuration information among the plurality of pieces of configuration information according to a preconfigured schedule;
using the storage controller to transmit, to the server computer, output information including the configuration information inside the storage controller based on the input information;
using the server computer to receive the output information and store the output information in association with the input information; and
using the server computer to transmit, upon receipt of the input information from a client computer, output information associated with the received input information to the client computer.
